(19) United States
(12) Patent Application Publication
(10) Pub. No.: US 2005/0110222 A1
(43) Pub. Date: May 26, 2005

(54) Multifunctional gasket

(75) Inventors: Kenji Matsumoto, Okayama (JP); Eiji Tomita, Okayama (JP); Sadami Yoshiyama, Okayama (JP)

Correspondence Address: BACON & THOMAS, PLLC, 625 SLATERS LANE, FOURTH FLOOR, ALEXANDRIA, VA, 22314, US

(73) Assignee: UCHIYAMA MANUFACTURING CORP., Okayama (JP)

(21) Appl. No.: 10/944,201

(22) Filed: Sep. 20, 2004

(30) Foreign Application Priority Data
Sep. 19, 2003 (JP) 2003-328759

(51) Int. Cl. F02F 11/00

(52) U.S. Cl. 277/592

(57) ABSTRACT

A multifunctional gasket for sealing a gap between two objects by being intervened therebetween, comprising a first base plate and a second base plate including a metal base plate, which is integrally formed thereon. The first base plate comprises a conductive metal base plate layer formed with first and second projecting portions and an opening portion corresponding to a cavity of said two objects, insulation layers integrally formed on both upper and lower surfaces of the conductive metal base plate layer, except for the first and second projecting portions as well as for the opening portion, and microseal coating layers coated on upper and lower surfaces of said insulation layers, whereas the second base plate is provided around the opening portion with an annular bead structure which is formed by being partially bent itself. The gasket is used such that the first projecting portion thrusts toward the opening portion, while the second projecting portion is exposed its outside.

### FIELD OF THE INVENTION

The present invention relates to a multi functional gasket which is interposed between two objects forming a space to be sealed such as a cylinder head and a cylinder block of an engine for sealing the gap between two objects or the space and which is capable of deriving information like the temperature, the pressure, the combustion condition (combustion time), the vibration, further the density, the concentration, or the component of gas or liquid in the space in the form of electric signals, and is capable of supplying a supplementary power for combustion and so on besides sealing the space.

### PRIOR ART

There has been disclosed a gasket in which a liner or probe type detection body is insulated and embedded therein, and such a gasket is intervened under pressure between a cylinder head and a cylinder block for directly detecting fire spreading in the combustion chamber in an automobile engine and the like. (For example, JP-A-63-66431 and JP-A-04-308339 propose and disclose such a gasket.) This type gasket, namely a gasket embedding an ion sensor is intervened under pressure between the cylinder head and the cylinder block and achieves an inherent sealing function as a gasket but detects the combustion condition in the combustion chamber by making the tip end of the electrode of the ion sensor face, applying a voltage between the electrode and the cylinder head or the cylinder block, and measuring the current at the moment when fire reaches at the end of the electrode.

The ion sensor described above is embedded in the gasket intervened under pressure between the cylinder head and the cylinder block, so that the installation position of the ion sensor isn't limited and the combustion condition at a desired area can be precisely detected. Therefore, such a kind of gasket has been widely utilized in the field of the automobile engine and so on.

The gasket disclosed in JP-B-06-84785 isn't such a gasket embedding an ion sensor, but is a gasket made of a metal plate coated with a compound layer including a basic fiber material, a rubber material, an inorganic filler material or the like on it. This type of gasket has been widely used not only for an engine but for others because they have a superior sealing efficiency and a thermal resistance achieved by the reinforcing function of a metal plate, prevention of drift of a rubber material because of the basic fiber, a peeling prevention function and so on.

When such a gasket embedding an ion sensor as mentioned above is intervened under pressure between the cylinder head and the cylinder block, it is required to keep the sealing function for gas around a cylinder bore by increasing the setting pressure against the upper and lower surfaces of the gasket. However, when trying to increase the setting pressure of the gasket, there would be caused a crack and so on in the gasket (insulation seal layer), which deteriorate the insulation of the ion sensor which is embedded in the gasket, because of the thickness of the electrode.

Therefore, it is thought that a crack may be prevented by making the electrode of the ion sensor as narrow or thin as possible. However according to such a narrow electrode, the tip end thereof at the combustion chamber side may be melted by the fire and an engine may be destroyed by pre-ignition phenomena which is caused by the fact the tip end turns into an ignition source. Gasket embedding an ion sensor (bore grommet type) in which the liner or probe type electrode as mentioned above is used also has such a problem that its production cost is increased because the ion sensor is made as such part as to be optionally attached to a gasket.

The gasket using a metal plate as disclosed in JP-B-06-084785 has a good sealing ability and a heat resistance and has no fear of causing crack in the compound layer because of the reinforcing function of a base fiber. However, there is no consideration about the electric conductivity of the metal plate or the electric insulation ability of the compound layer, so that such a gasket hasn't been applied to the gasket with an ion sensor function.

### SUMMARY OF THE INVENTION

The present invention has been proposed to solve the above-mentioned problems and its object is to provide a multifunctional gasket not for engines but for machinery that needs various seals, in which its sealing ability is preferably kept, the above-mentioned crack and the like aren't caused, the electrical information in the space to be sealed is preferably taken out as electric signals, an electrical operation is added by providing electric power or electric signals into the space as the like, and further multipurpose function is achieved for controlling the engine and other equipment which require several kinds of sealing.

A gasket of the present invention is following in order to solve the mentioned problems.

Namely a gasket of the present invention is a multifunctional gasket for sealing a gap between two objects by being intervened therebetween, comprising a first base plate and second base plate including a metal base plate, which is integrally formed thereon, wherein the first base plate comprises a conductive metal base plate layer formed with first and a second projecting portions and an opening portion corresponding to a cavity of that two objects, insulation layers integrally formed on both upper and lower surfaces of the conductive metal base plate layer, except for the first and second projecting portions and the opening portion, and microseal coating layers coated on the upper and lower surfaces of the insulation layers, and wherein the second base plate is provided around the opening portion with an annular bead structure which is formed by being partially bent itself, further wherein when the gasket is intervened between that two objects for use, the first projecting portion thrusts toward the opening portion, while the second projecting portion is exposed outside of the gasket.

The gasket mentioned above is preferably applicable to an engine. In this case, that two objects are a cylinder block and a cylinder head of an engine respectively and the cavity is a cylinder bore.

Further in a preferable embodiment of the present invention, the second base plate is made as a composite base plate that a compound material containing a mixture of a fiber material and a rubber is coated on the upper and lower surfaces of the metal base plate.

Besides the conductive metal base plate layer is constructed such that the electric information generated in the cylinder bore is derived therethrough and an electric power is supplied to an electric equipment provided in the cylinder bore therethrough.

And further a multi-channel type gasket is presented too, wherein the first base plate further comprises plural conductive metal members separately insulated each other between the conductive metal base plate and the insulation layer and through which various electrical information is derived from plural points of the cavity.

Or the first base plate comprises plural conductive metal members separately insulated each other, as a substitute for the conductive metal base plate and through which various electrical information is derived from plural points of the cavity.

According to the present invention, following effects could be expected.

When a gasket is fastened while being intervened between two objects, the restoring force accompanied with an elastic deformation by the compressed bead structure of the second base plate acts on the facing surfaces between two objects and their mutual setting pressure intervening the gasket is strongly kept. Therefore, the sealing of the space to be sealed is extremely preferably kept. Further, a microseal coating layer of the first base plate is intervened between the insulation layer and the end surface of one of the two objects, thereby filling small convexo-concave parts of these surfaces, and the conductive metal base plate layer of the first base plate and the metal base plate of the second base plate further reinforce the gasket.

When the gasket mentioned above is used in the state intervened between two objects, the first projecting portion at the space side of the conductive metal base plate layer faces the space and the other projecting portion is exposed outside, so that the electrical information in the space is introduced as electric signals from the conductive metal base plate layer. Or when a heater and the like is connected to the projecting portion at the space side of the conductive metal base plate layer and a power voltage is applied at the other end, the electrical load is acted in the space. Further, the conductive metal base plate layer is constructed such that the insulation layers are attached on its upper and lower surfaces to be integrated, so that the conductive metal base plate layer is electrically insulated from the two objects and it has no fear of leakage of the electric signals based on the electrical information to the two objects, thereby enabling to take out the electric signals with high accuracy and to act the electrical load.

In addition, a bent part including a bead structure effective for a improving sealing ability is formed only on the second base plate comprising the metal base plate, so that the first base plate is free from being bending. Therefore, an insulation layer, which is usually made of a fragile material such as ceramic, becomes free from crack and peeling caused by a bending process. Accordingly, the first base plate can provide a multifunctional gasket having a preferable insulation ability and a superior reliability.

In a case the second base plate is a composite base plate formed such that a compound material in which a fiber material is mixed with rubber is coated on the upper and lower surfaces of the metal base plate, the following advantages are expected comparing to the plate that is formed by coating the metal base plate only with a synthetic rubber layer.

Namely the thermal resistance is improved, drift and peeling of the coating layer are prevented and further a torque retention characteristic is improved because the compound material that contains a fiber material mixed with rubber is coated on the metal base plate.

And besides the thickness of coating layer is able to be made large up to 200μ at one side. Therefore, when the second base plate that is effective for improving the sealing ability as a sealing material is joined in layer to the first base plate effectively functioning without having a curved portion, a multifunctional gasket with a conductive metal base plate layer can be provided with a preferable sealing ability and a reliable insulation ability.

In the case that a gasket of the present invention is applied to a gasket for engines and such an applied gasket is intervened between a cylinder block and a cylinder head to be jointly installed, the projecting portion at the space side of the conductive metal base plate layer, namely the side of a cylinder bore faces to the cylinder bore (a combustion chamber) and the other projecting portion is exposed outside the engine.

Therefore, when the cylinder head and/or the cylinder block are grounded, a power source is connected to the exposed projecting portion, and an electric potential (for example 90V) is applied therebetween, a circuit is constructed via a fire area in ionic conditions at the moment when a fire is reached to the projecting portion of the conductive metal basic plate layer which is an electrode provided so as to face the combustion chamber of the engine. The current value at the moment is amplified by an amplifier to be processed in an information processing unit, thereby detecting the combustion characteristic in the combustion chamber (combustion time, namely the time that the combustion proceeds).

Other than detecting the combustion characteristic (combustion time and so on) in the combustion chamber in the engine, the temperature, pressure, vibration, gas concentration, gas component, fuel concentration, fuel density and the like in the combustion chamber can be derived in the form of electric signals by connecting a suitable sensor (specified later) to the conductive metal base plate layer. The current (power) may be supplied from the outside of the cylinder block into the electric equipment such as a preheater provided for the cylinder bore by utilizing the conductive metal base plate layer as a conduction member. Further, this invention can be applied to detect the conditions mentioned above in the space of the equipment, other than an engine, having the space to be sealed.

According to another multifunctional gasket of the present invention, plural conductive metal plates are arranged in array within the first base plate, so that plural sensors can be easily provided for these conductive metal plates. Further, plural conductive metal plates are arranged in array, not in layer, thereby making the thickness of the gasket thin.

According to the present invention, the insulation layer is formed with a polyimide resin, so that its insulation ability becomes superior.

### BRIEF DESCRIPTION OF THE DRAWINGS

FIG. 1 is a partially cutout enlarged sectional view showing one embodiment of a multifunctional gasket of the present invention.

FIG. 2 is a vertical sectional view showing an essential part of an engine assembled with a multifunctional gasket of the present invention.

FIG. 3 is an enlarged view of the part “X” of FIG. 2.

FIG. 4 is an enlarged view of the part “X” of the modified embodiment of a multifunctional gasket of the present invention.

FIG. 5 is an enlarged view of the part “X” showing an embodiment in which a sensor is embedded in the internal wall of a combustion chamber of an engine.

FIG. 6 is an enlarged view of the part “X” of a modified embodiment of a multifunctional gasket of the present invention.

FIG. 7 is an enlarged view of the part “X” of other embodiment of a multifunctional gasket of the present invention.

FIG. 8 is an enlarged view of the part “X” of still other embodiment of a multifunctional gasket of the present invention.

FIG. 9a-FIG. 9c are sectional views showing other construction of the second base plate.

FIG. 10 is a sectional view of an essential part of a multifunctional gasket in which the first base plate is formed with a rib.

FIG. 11 is a perspective view showing a multifunctional gasket with multi-channel in array.

FIG. 12a shows a 5-channel type gasket and FIG. 12b shows a 4-channel type gasket.

FIG. 13 is a perspective view showing an integrated construction of the side end for taking out a conductive metal base plate of FIG. 11.

FIG. 14 is an integrated construction of FIG. 13, FIG. 14a shows a 5-channel gasket and FIG. 14b shows a 4-channel gasket.

FIG. 15 is a perspective view of an essential part of a multifunctional gasket of which a conductive metal base plate layer is a bias layer.

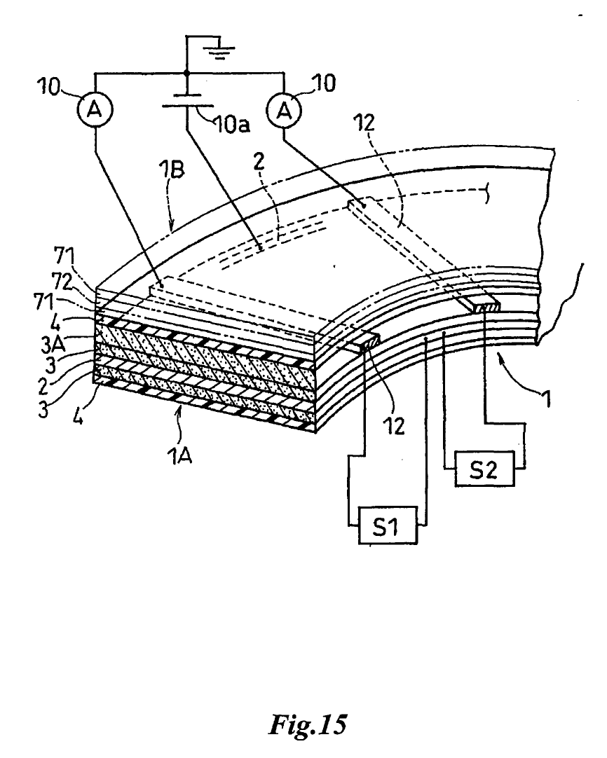

### DETAILED DESCRIPTION OF THE INVENTION

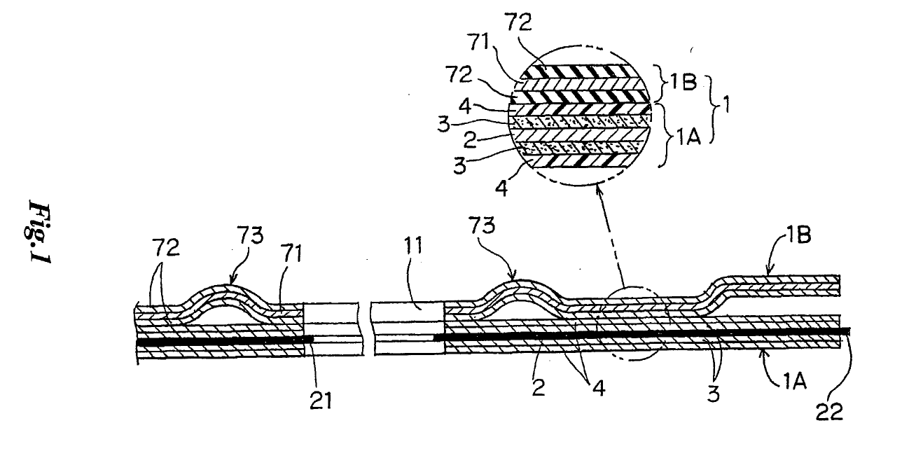

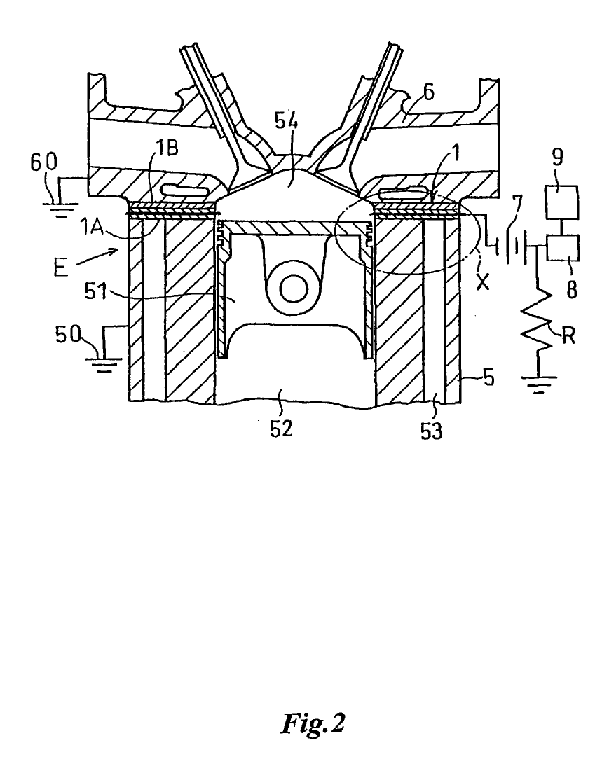

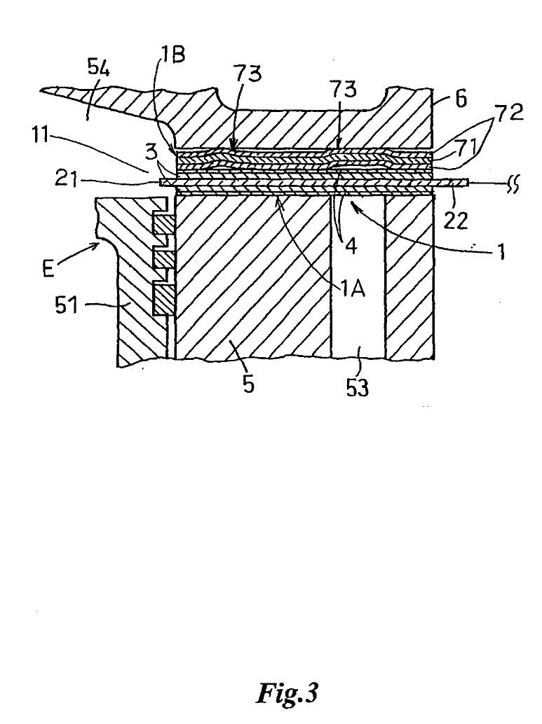

Now preferred embodiments of the present invention especially for a vehicle engine are explained referring to the attached drawings. FIG. 1 is a partially cutout enlarged sectional view showing one embodiment of a multifunctional gasket of the present invention, FIG. 2 is a vertical sectional view showing an essential part of an engine assembled with the multifunctional gasket, FIG. 3 is an enlarged view of the part “X” of FIG. 2.

### Preferred Embodiment 1

In FIG. 1, a multifunctional gasket 1 of the present invention is a joined body of a first base plate 1A and a second base plate 1B in layer. The first base plate 1A is comprised of a conductive metal base plate layer 2, an electric insulation layer 3 integrally formed on the upper and lower surfaces of the conductive metal base plate layer 2, and microseal coating layers 4 coated on the outer surfaces of the electric insulation layer 3, and the second base plate 1B is comprised of a metal base plate 71. The second base plate 1B is a composite base plate (rubber coat metal) formed such that a compound material 72 in which a fiber material is mixed with rubber is coated on the upper and lower surfaces of the metal base plate 71. Namely, the first base plate 1A is constructed as a metal gasket for detecting electric signals and the second base plate 1B is constructed as a rubber coat metal gasket respectively.

The above-mentioned multifunctional gasket 1 has an opening 11 formed corresponding to a space to be sealed (a cylinder bore in case of an engine), through which one object communicates with the other, and an annular bead structure 73 is formed around the opening 11 of the second base plate 1B. The conductive metal base plate layer 2 is slightly projected into the inner periphery of the opening 11 to form the first projecting portion (endpoint at the space side) 21 and a second projecting portion 22 is formed such that the conductive metal base plate layer 2 is partially exposed at the outer periphery of the multifunctional gasket 1.

According to the first base plate 1A, the conductive metal base plate layer 2 is formed of any one of metal sheet with 0.05 to 0.5 mm thickness, selected from a low carbon steel sheet, a stainless steel sheet, an aluminum sheet, and a copper sheet. The electric insulation layer 3 has a thickness of 0.1 μm to 0.5 mm and is formed of any one of a processed layer selected from a polyimide resin, a plastic layer, a ceramic (silic acid or alumina) layer, a ceramic fiber layer, a diamond-like carbon layer, an asbestos layer, an adhesive layer, or such conductive metal base plate layer of which the surface is processed with a metal surface processing agent. The electric insulation layers 3 are integrally formed on the upper and lower surfaces of the conductive metal layer 2. The metal surface processing agent is a rust-preventive agent, a surface curing agent, a surface lubricant, a friction/abrasion reducing agent or galvanizing in order to be used for protecting the conductive metal base plate layer 2 or assuring its familiarity and the processed layer by these processing agent forms the electric insulation layer 3.

The microseal coating layer 4 has a thickness of 1 μm to 0.5 mm and is formed of such layer that any one of layer selected from a rubber material including an inorganic powder material, a plastic material, or an adhesive is integrally covered on the electric insulation layer 3. More specifically, a layer in which a synthetic resin is mixed as a binder in graphite, a synthetic resin layer in which silica, calcium carbonate, magnesium oxide, aluminum oxide or the like is used as a filler, or a rubber layer such as silicone is applied.

It was cleared by the experiment that when the aforementioned polyimide was used as an insulation layer, its insulation ability was superior. The polyimide film (50 μm thickness) is attached by heat adhesion (200° C., two hours) by means of a polymide adhesive on both sides of a stainless sheet (0.3 mm thickness) to form the first base plate 1A and the electric resistance is measured. The resistance between the stainless sheet and the earth was ∞ ohm.

Characteristic of Polyimide

| Characteristic | RT | 200° C. |
|---|---|---|
| tensile strength | 338 Mpa | 225 Mpa |
| tensile extension | 80.0% | 100.0% |
| tensile elasticity module | 3.3 Gpa | 2.1 Gpa |
| volume resistance | 1 × 10¹⁸ Ω cm | 1 × 10¹⁴ Ω cm |
| insulation breaking strength | 400 KV/mm | 320 KV/mm |

Fiber material of the second base plate 1B includes an inorganic fiber like glass fiber, ceramic fiber, asbestos, mineral wool, soluble quartz fiber, chemical treating high silica fiber, fused aluminum silicate fiber, alumina continuous fiber, stabilized zirconia fiber, boron nitride fiber, titanic acid alkali fiber, whisker, carbon fiber, metal fiber, boron fiber and the like. Fiber material also includes an organic fiber like aromatic polyamide fiber, polyamide fiber, polyolefin fiber, polyacrylonitrile fiber, polyvinyl alcohol fiber, polyvinyl ester fiber, polyvinyl chloride fiber, polyurea fiber, polyurethane fiber, polyfluorocarbon fiber, phenol fiber, cellulosic fibers and the like. Rolled sheets of steel such as SPPC, SPHC and the like, an aluminum sheet, a stainless steel sheet, and the like may be used as the metal base plate 3.

Rubber (rubber material) is for example, nitrile rubber (NBR), styrene butadiene rubber (SBR), isoprene rubber (IR), chloroprene rubber (CR), butadiene rubber (BR), butyl rubber (IIR), ethylene propylene rubber (EPM), fluororubber (FPM), silicone rubber (Si), chlorosulfonated polyethylene (CSM), ethylene vinyl acetate ruber (EVA), polyethylene chloride (CPE), butyl chloride rubber (CIR), epichlorohydrin rubber (ECO), nitrilo isoprene rubber (NIR), natural rubber (NR), and the like. Oil extension rubber formed such that naphthene process oil is added into these rubber materials like SBR may be used.

The multifunctional gasket 1 is formed as follows. A sheet metal work is made on the metal sheet for the conductive metal base plate layer 2 so as to form a predetermined shape including a bore corresponding to the opening 11, the electric insulation layers 3, 3 and the microseal coating layers 4, 4 are formed to be integrated, thus the first base plate 1A is formed. The compound material 72 is coated on the upper and lower surfaces of the metal base plate 71 to form a composite base plate, press molding is made on the composite base plate to form a bead structure 73 projecting into the opposite side of the first base plate 1A, thus the second base plate 1B is formed. The first base plate 1A and the second base plate 1B are joined in layer by partially crimped (or by means of adhesive).

The bead structure 73 effective for improving a sealing ability is thus formed on the second base plate 1B and no bending process is done for the first base plate 1A. Therefore, the electric insulation layer 3 formed with a comparatively fragile material such as ceramic does not cause crack and peeling derived from bending procedure, so that the first base plate 1A is constructed so as to keep a preferable insulation ability. The first base plate 1A and the second base plate 1B are required not to separate at least during assembly. Accordingly they may be partially crimped by striking the second base plate 1B by means of a mallet or they may be lightly attached by applying adhesive on several parts.

The case when the above-mentioned multifunctional gasket 1 is incorporated into an engine is explained referring to FIG. 2 and FIG. 3. The reference “E” indicates an engine assembled such that the multifunctional gasket 1 is provided on a cylinder block 5 and a cylinder head 6 is placed thereon so that the gasket 1 is intervened therebetween. The reference numeral 51 indicates a piston reciprocating up and down in a cylinder bore (communicating cavity is formed in this embodiment) 52 of the cylinder block 5 and the space formed with the upper end of the piston 51 and the lower end of the cylinder head 6 is defined as a combustion chamber 54. The reference numeral 53 indicates a cooling medium communicating bore formed in the cylinder block 5 and is opened at the upper end surface of the cylinder block 5. Water, antifreeze liquid or oil is supplied to the cooling medium communicating bore 53.

According to thus assembled engine E, the facing surfaces of the cylinder block 5 and the cylinder head 6 are completely sealed with the multifunctional gasket 1 so as not to leak the combustion gas out of the combustion chamber 54. Specifically, the bead structure 73 is elastically deformed like FIG. 3 when being fastened and the setting pressure of the facing surfaces of the cylinder block 5 and the cylinder head 6 is strongly kept by the multifunctional gasket 1 intervened therebetween because of the restoring force of the elastic deformation. In addition, when the electric insulation layer 3 mentioned above is applied, a drift isn't caused in case of screwing, thereby preventing reduction of the screwing force.

Further, because the microseal coating layers 4, 4 are contacted to the facing surfaces under pressure, the microseal coating layer 4 fills small concaves and convexes on the facing surfaces, thereby improving the sealing ability. Surface finishing is executed on the electric insulation layer 3 during forming process and the micro concaves and convexes are produced on its surface. However, the microseal coating layer 4 also fills those micro concaves and convexes to be tightly attached to the electric insulation layer 3 to be integrated. The microseal coating layer 4 not only fills the micro concaves and convexes but also achieves insulation function. The conductive metal base plate layer 2 is electrically insulated from the facing surfaces by the electric insulation layers 3, 3 which are integrated with the upper and lower surfaces of the layer 2.

The second base plate 1B is provided with the annular bead structure 73 which is formed by bending the plate 1B and is arranged around the opening 11 formed corresponding to the cylinder bore 52. The first base plate 1A is constructed such that the first projecting portion of the conductive metal base plate layer 2 at the cylinder bore side faces the inside of the cylinder bore 52 and the other projecting portion thereof is exposed the outside when the multifunctional gasket 1 is intervened between the cylinder block 5 and the cylinder head 6 to be screwed.

The projecting portion 21 of the conductive metal base plate layer 2 faces the combustion chamber 54 and is used as an electrode for detecting the ion current at the combustion gas side. The projecting portion 21 into the combustion chamber 54 as the electrode at the combustion gas side may be all around the inner circumference of the opening 11 or may be a part thereof. As shown in FIG. 2, a power 7, an amplifier 8 and a signal processing unit 9 are connected to the exposing portion 22 of the conductive metal base plate layer 2 when the engine E is assembled. The cylinder block 5 and the cylinder head 6 are grounded as shown like the reference numeral 50, 60, however, either one of them may be grounded.

When voltage, for example 90V, is applied by means of the power source 7 between the exposing portion 22 and the cylinder block 5 and the cylinder head 6 which are ground electrodes, a circuit is formed via a fire area under ionic condition at the moment when fire is reached to the projecting portion 21 as an electrode projecting into the combustion chamber 54. The instant current value is amplified with the amplifier 8 to be processed in the signal processing unit 9, thereby detecting the combustion characteristic (combustion time and so on) in the combustion chamber 54. The conductive metal base plate layer 2 functions as a core material of the multifunctional gasket 1 and also functions as an ion sensor of fire in the combustion chamber 54.

As mentioned above, the bending procedure for forming the bead structure 73, which may cause deformation of the base plate in case of assembly, is done for the second base plate 1B of the multifunctional gasket 1, so that the first base plate 1A with the conductive metal base plate layer 2 and the electric insulation layer 3 is plane without bent parts. The first base plate 1A is formed by coating an insulation material on a flat plate, so that it can prevent crack of the electric insulation layer 3 when receiving the compression force in case of being assembled as a gasket. The microseal coating layer 4 of the first base plate 1A at the second base late 1B side can be made thinner comparing to the case without the second base plate 1B and further it can coat a conductive material. Still further, a layered multi-channel type multifunctional gasket that has plural conductive metal base plate layers 2 in layer under the electric insulation layer 3, or an arrayed multi-channel type multifunctional gasket of which signals are multi-channel (mentioned later) may be obtained.

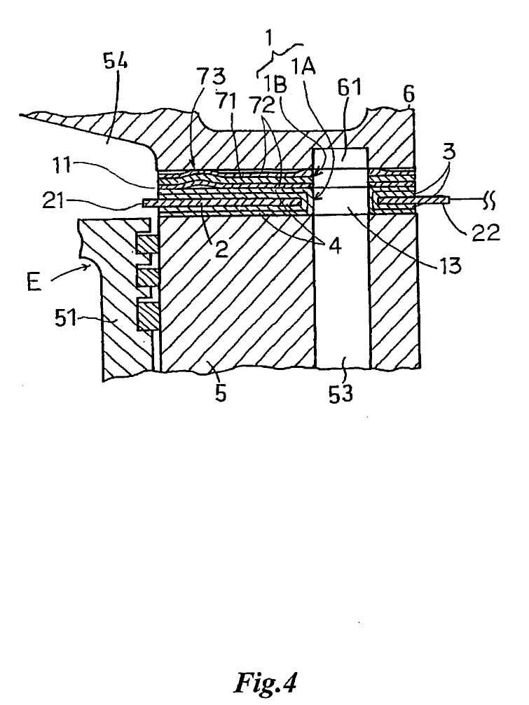

According to the embodiment shown in FIG. 4, a cooling medium communicating bore 61 is formed in the cylinder head 6 corresponding to the cooling medium communicating bore 53, a cooling medium is communicated through both cooling medium communicating bores 53, 61 so as to be applied for cooling the engine. A communicating bore 13 is provided for the multifunctional gasket 1 at the position corresponding to the openings of both cooling medium communicating bores 53, 61. The electric insulation layer 3 and the microseal coating layer 4 are formed so as to cover the opening edge of the communicating bore 13 of the conductive metal base plate layer 2. Therefore, while keeping communication of the cooling medium through both cooling medium communicating bores 53, 61, its leak prevention function is achieved as mentioned above. Other construction is the same as that mentioned above and the same reference numerals are allotted to omit the explanation.

According to the multifunctional gasket 1 of the preferable embodiment 1, the combustion gas is completely prevented from leaking out of the combustion chamber 54. In addition, when the cylinder head and/or the cylinder block are grounded, a power source 7 is connected to the exposed part 22, and electric potential is applied therebetween, a circuit is constructed via a fire area in ionic conditions at the moment when a fire is reached to the end of the conductive metal basic plate layer 2 which is an electrode provided so as to face the combustion chamber 54 of the engine. The current value at the moment is amplified by the amplifier 8 to be processed in the information processing unit 9, thereby detecting the combustion characteristic in the combustion chamber 54 (combustion time).

The electric insulation layer 3 has a thickness of 0.1 μm to 0.5 mm and is formed of any one of a process layer selected from a plastic layer, a ceramic layer, a ceramic fiber layer, a diamond like carbon layer, an asbestos layer, an adhesive layer, or such a processed layer formed by processing the surface of the conductive metal base plate layer 2 with a metal surface processing agent, thereby preferably keeping its electric insulation ability. If polyimide is used for the electric insulation layer, its insulation ability becomes superior. Further, the electric insulation layer 3 does not cause any crack in case of assembly different from the prior art provided with a liner or probe type electrode.

### Preferred Embodiment 2

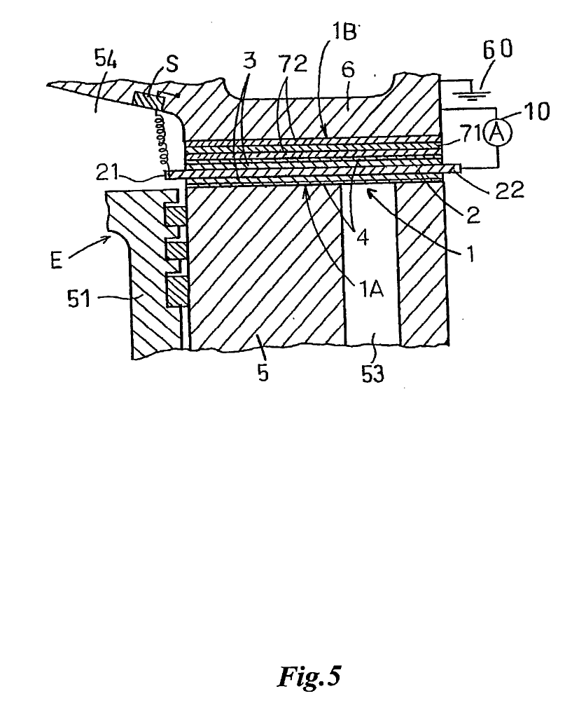

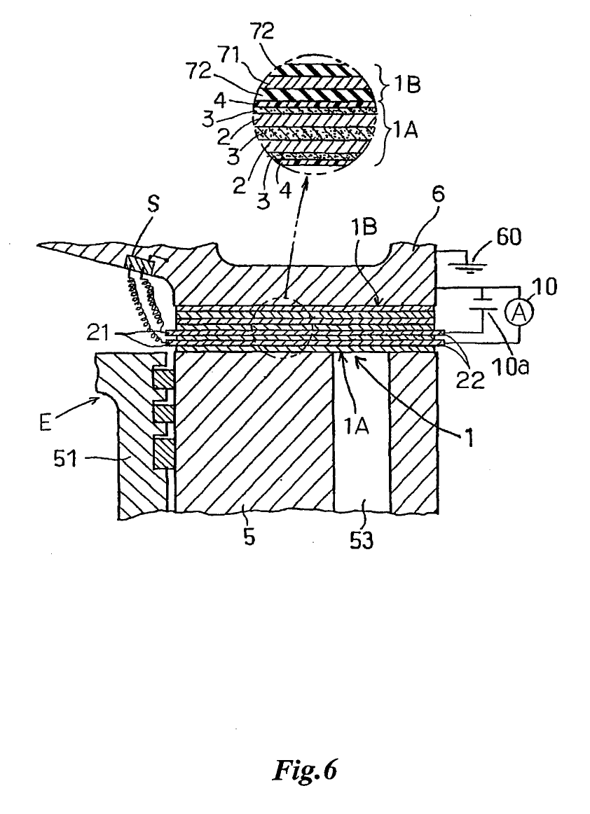

In FIG. 5 and FIG. 6, several kinds of sensors S are embedded in the inner wall of the combustion chamber 54, and the sensor S and the conductive metal base plate layer 2 are electrically connected, so that the electrical information of the sensor S is converted into electric signals to be taken out. Examples of the sensor S are a piezo resistance type pressure sensor utilizing that a specific resistance is changed by pressure, a semiconductor titania O₂ sensor for detecting an air fuel ratio, a sensor utilizing a yttria type perovskite semiconductor for measuring temperature and resistance, a silicone strain gage as a pressure-voltage converting element, a knocking sensor for detecting vibration, and so on.

The exposing portion 22 of the conductive metal base plate layer 2 and the grounded cylinder head 6 are connected via an ampere meter 10, thereby reading the characteristic change in each sensor S by changing the current in the ampere meter 10. FIG. 6 shows an embodiment using a two-wire system sensor as a sensor S and for this purpose the multifunctional gasket 1 of the present embodiment is formed with the first base plate 1A comprising two layered conductive metal base plate layers 2, 2. Namely, the first base plate 1A is constructed such that the electric insulation layer 3 at the center is put between the two layered conductive metal base plate layers 2, 2, the electric insulation layers 3, 3 are formed on outside thereof respectively, and further the microseal coating layers 4, 4 are coated as the most outer layer respectively. Two leads from the sensor S are electrically connected to the two layered conductive metal base plate layers 2, 2 respectively. The reference numeral 10a indicates a DC power source.

The construction of the second base plate 1B is the same as that shown in FIG. 1-FIG. 3. Although the bead structure 73 isn't shown in FIG. 5 and FIG. 6, it goes without saying that there is a bead structure as mentioned above. Other construction is the same as that mentioned above, so that the common members have the same reference numerals to omit their explanation.

### Preferred Embodiment 3

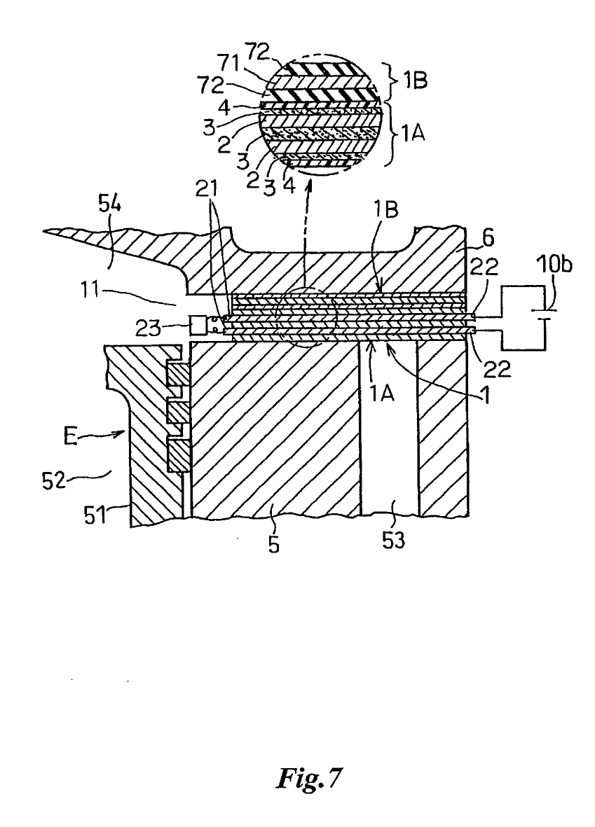

FIG. 7 shows an embodiment in which the fuel or inhalation gas in the cylinder block 5, the cylinder head 6, and the combustion chamber 54 of the engine E is able to be preliminary heated. A heater 23 is connected to the ends 21, 21 at the cylinder bore 52 side of the conductive metal base plate layers 2, 2 of the multifunctional gasket 1 like FIG. 6 and a power source 10b is connected to the other ends 22, 22, enabling to apply voltage to the heater 23 via the conductive metal base plate layers 2, 2. Thus applied voltage makes the heater 23 (one example of electric equipment) generate heat and makes the fuel or inhalation gas in the cylinder block 5, the cylinder head 6, and the combustion chamber 54 of the engine E increase temperature, thereby achieving efficiency of driving an engine at cold districts.

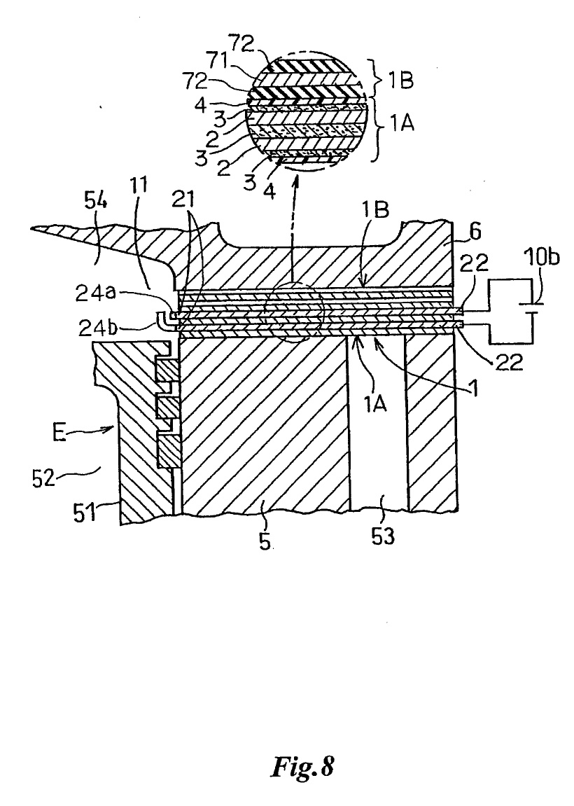

FIG. 8 shows an embodiment wherein a supplemental discharge of combustion in the combustion chamber 54 is able in the above-mentioned engine E. Discharge electrodes 24a, 24b (one example of electric equipment) are provided at the ends 21, 21 at the cylinder bore 52 side of the conductive metal base plate layers 2, 2 of the multifunctional gasket 1 like FIG. 6, the power source 10c is connected to the other ends 22, 22, thereby enabling to apply voltage between the electrodes 24a, 24b via the conductive metal base plate layers 2, 2 (the whole periphery excepting electrodes is isolated). As the result, electric discharge is done between both electrodes 24a, 24b to promote combustion in the combustion chamber 54, preventing knocking to contribute to the combustion efficiency.

According to the heater 23 and the discharge electrodes 24a, 24b of the embodiments shown in FIG. 7 and FIG. 8, plural heaters and plural discharge electrodes are provided along the circumference of the cylinder bore 52 with a space and the number thereof is optionally determined. Also in FIG. 7 and FIG. 8 the bead structure 73 isn't shown, however, it goes without saying that it exists as mentioned above. Other constructions of this embodiment is the same as those mentioned above, therefore, the common members also have the same reference numerals and their explanations are omitted here.

The multifunctional gasket 1 shown in FIG. 7 can achieve efficiency of driving an engine at cold districts. The multifunctional gasket 1 shown in FIG. 8 can prevent knocking of engine and contribute efficiency of combustion, thereby expecting to be used for many purposes. Namely, the electrical information in the cylinder bore 52 is derived in the form of electric signals via the conductive metal base plate layer 2 and/or electric power is able to be supplied to the electric equipment 23, 24a, 24b provided for the cylinder bore 52.

### Preferred Embodiment 4

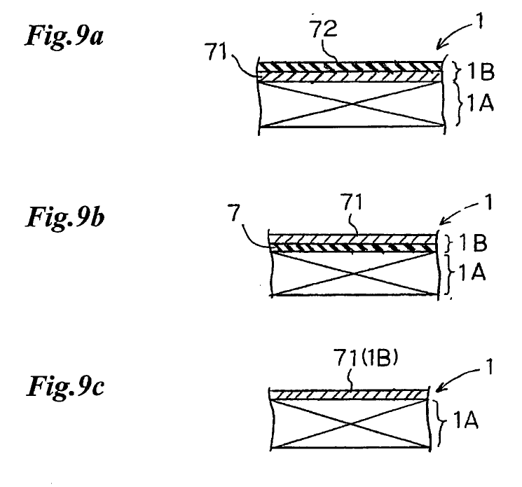

The second base plate 1B may be two-layer construction such that the compound material 72 is coated only on one side of the metal base plate 71 as shown in FIG. 9a and FIG. 9b or it may be a single layer construction comprising the metal base plate 71 as shown in FIG. 9c. In FIG. 9a the compound material 72 exists on one side of the metal base plate 71 opposite to the first base plate 1A and in FIG. 9b the compound material 72 exists on one side of the metal base plate 71 facing the first base plate 1A.

### Preferred Embodiment 5

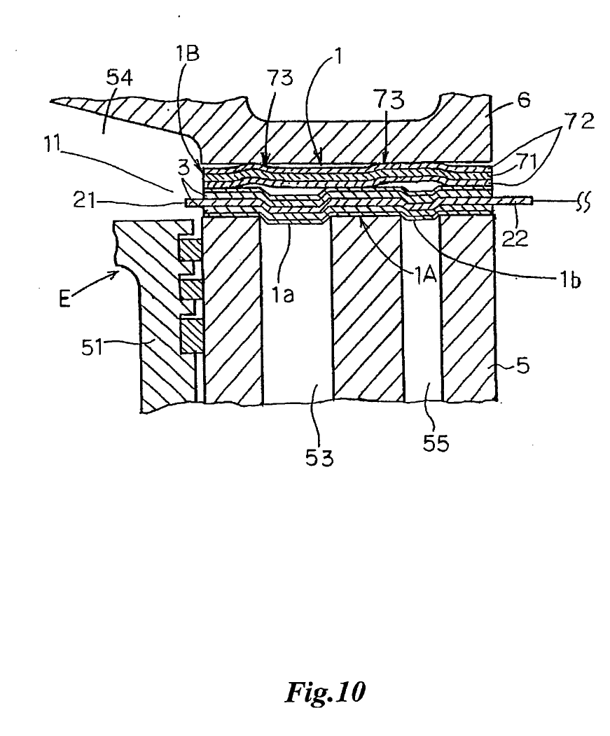

The multifunctional gasket 1 may be provided with reinforcing ribs 1a and 1b at appropriate positions of the first base plate 1A as shown in FIG. 10. Parts corresponding to the cooling medium (cooling water) communication bore 53 and a lubrication oil communication bore 55 are projected downward to form the ribs 1a and 1b, thereby improving the strength and rigidity of the first base plate 1A, namely the multifunctional gasket 1, without damaging the function of the gasket 1. Other construction is the same as that shown in FIG. 3 and the same reference numerals are allotted to omit the explanation.

### Preferred Embodiment 6

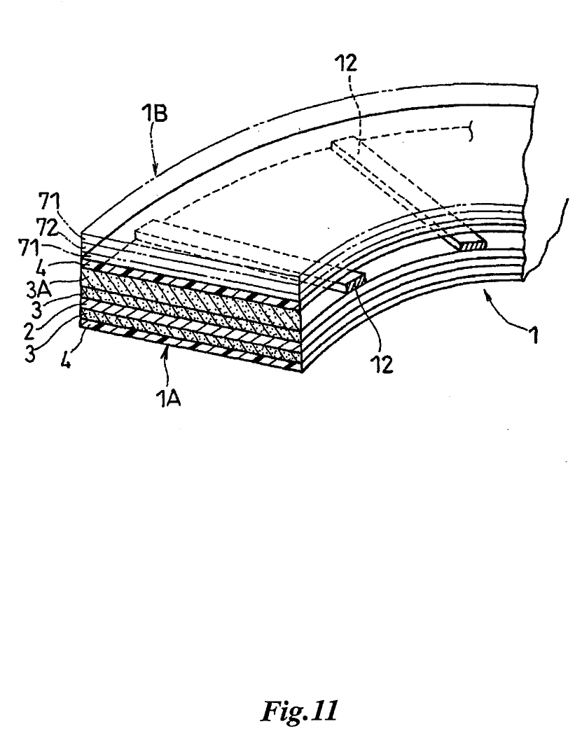

The multifunctional gasket 1 may be constructed as a multi-channel type as shown in FIG. 11. In the first base plate 1A, a thick second electric insulation layer 3A is formed between any one of electric insulation layers 3 and the microseal coating layer 4 outside thereof and plural conductive metal members 12 are embedded in the second electric insulation layer 3A so as to be arranged in a radial pattern when seen from the top with an equal interval in a circumferential direction. Here are formed that metal members by patterning a metal sheet or film.

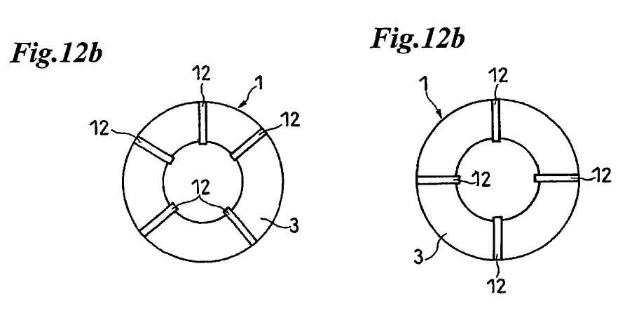

Five conductive metal films 12 (one example of conductive metal material) like a bar are provided in array within the second electric insulation layer 3A formed on the upper electric insulation layer 3 in a radial manner per equal angle around the cylinder bore seen from the top and they are put on the lower electric insulation layer 3 as shown in FIG. 12a, thereby realizing a five-channel type multifunctional gasket. Namely the first base plate 1A is constructed such that the five (one example of plural numbers) conductive metal films 12 are separated and insulated from each other and arranged in array between the conductive metal plate layer 2 and the second electric insulation layer 3A, the five conductive metal films 12 being insulated from the conductive metal plate layer 2 and facings the cylinder bore 52 that is a sealed space.

Although omitted in the figure, a conductive lead wire is connected at the outer end of each conductive metal plate film 12 like the conductive metal plate layer 2. Namely that is a multifunction gasket having such a layered structure that the electric insulation layer 3 is formed on the surface of the conductive metal plate layer 2 as a conductive metal plate layer and an electric circuit comprising the conductive metal member 12 is further formed thereon, and there are arranged plural conductive metal films 12 in parallel.

The combustion condition in the combustion chamber 54 is not uniform and is usually different at each position, namely around the ignition device, at inhale side, at discharge side and so on. When plural conductive metal members 12 are thus provided so as to detect at plural circumferential parts with respective projecting portions, the combustion condition can be understood in more detail and the combustion characteristic in the combustion chamber 54 in the engine E can be detected more precisely. In addition, plural kinds of signals can be simultaneously taken out. The plural conductive metal members 12 are not always required to be arranged with the equal angle. For example, the conductive metal films 12 may be concentrated at the position of which the detail information is required or may be preferably concentrated at one position in view of availability of taking out signal lines.

According to the multifunctional gasket 1 with a parallel multi-channel, plural conductive metal members 12 are not in layer, so that the gasket can be made thinner and be multi-channel by increasing the number. Thin film in A level is made possible by the technology such as ion plating and spattering, thereby utilizing an advanced film technology. As shown in FIG. 12b, the multifunctional gasket 1 may be four-channel type in which four conductive metal members 12 are arranged with equal angle (or other than equal angle).

### Preferred Embodiment 7

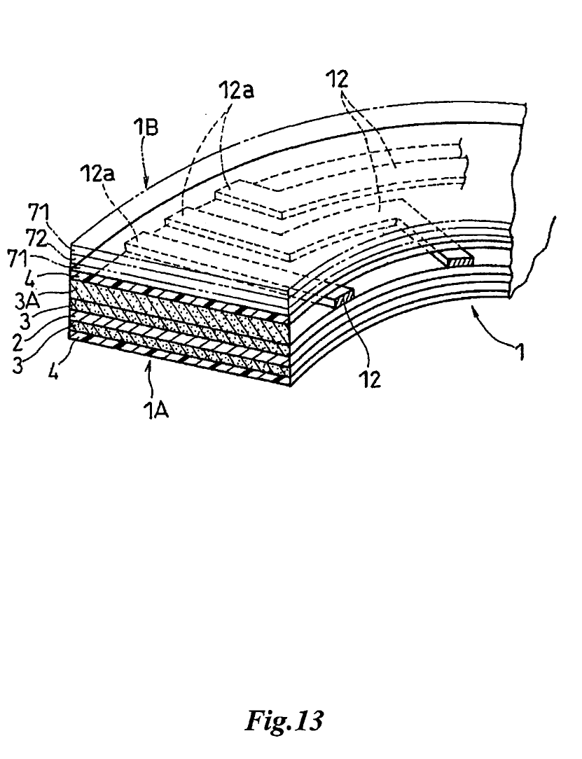

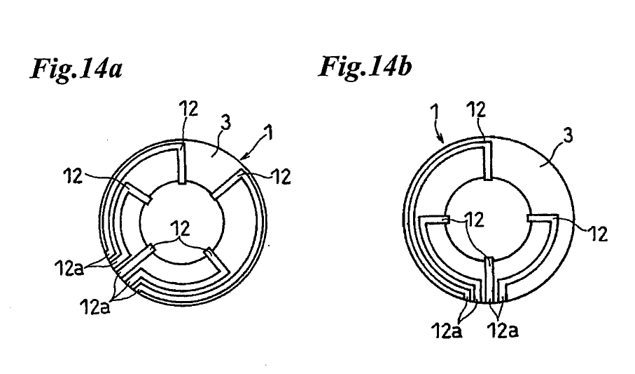

The multifunctional gasket 1 as shown in FIG. 11 may be constructed such that the conductive metal film 12 is bent and the end 12a at the take-out side (opposite to the cylinder bore) is preferably concentrated at one place, as shown in FIG. 13. If there are five conductive metal members 12, five ends 12a at take-out side are arranged at one place as shown in FIG. 14a. If there are four conductive metal members 12, four ends 12a at take-out side are arranged at one place as shown in FIG. 14b.

When plural ends 12a at take-out side are concentrated, leads wire connected to the conductive metal members 12 is shortly arranged to be taken out when an interface is constructed by connecting the conductive metal members 12 and ECU (engine control unit), thereby facilitating the connector for wiring.

### Preferred Embodiment 8

If the multifunctional gasket 1 is a parallel multi-channel type as shown in FIG. 11 and FIG. 13, the conductive metal plate layer 2 connected with the positive pole of the power 10a is commonly used as one pole, each conductive metal members 12 connected with the negative pole via the ampere meter 10 is used as other pole, and plural sensors S1 and S2 are connected. Namely, the conductive metal base plate layer 2 is used as a bias layer. Although it is not shown in the figure, the conductive metal plate layer 2 connected with the negative pole of the power 10a is commonly used as one pole, each conductive metal members 12 connected with the positive pole of the power 10a via the ampere meter 10 is used as other pole, and the conductive metal plate layer 2 may be used as a ground layer (earthing layer).

In the above-mentioned embodiments, the present invention is applied to a vehicle engine and the like, however, the present invention isn't limited to that. It can be widely applied to a gasket which is intervened between two objects enclosing a space to be sealed jointly. Further if it is used for the vehicle engine, the engine is not only limited to a single cylinder, but also is applied to an engine comprised of multi cylinders. In this case, it is optionally selected whether one multifunctional gasket 1 mentioned above is provided for each cylinder or one multifunctional gasket 1 which is commonly used for multi cylinders is provided. In case of the multi-channel type, the number of conductive metal members 12 may be other than four or five.

In another constitution of a multi channel type multifunctional gasket, not a conductive metal base plate layer 2 but plural conductive metal plates 12 insulated from each other are provided for the gasket (not indicated in any figures).

1. A multifunctional gasket for sealing a gap between two objects by being intervened therebetween, comprising a first base plate and a second base plate including a metal base plate, which is integrally formed thereon,
wherein said first base plate comprises a conductive metal base plate layer formed with first and second projecting portions and an opening portion corresponding to a cavity of said two objects, insulation layers integrally formed on both upper and lower surfaces of said conductive metal base plate layer, except for said first and second projecting portions and said opening portion, and microseal coating layers coated on upper and lower surfaces of said insulation layers,
and wherein said second base plate is provided around said opening portion with an annular bead structure which is formed by being partially bent itself,
further wherein when said gasket is intervened between said two objects for use, said first projecting portion thrusts toward said opening portion, while said second projecting portion is exposed outside of said gasket.

2. The multifunctional gasket as set forth in claim 1, wherein said second base plate is made as a composite base plate that a compound material containing a mixture of fiber material and rubber is coated on the upper and lower surfaces of said metal base plate.

3. The multifunctional gasket as set forth in claim 1, wherein said two objects are a cylinder block and a cylinder head of an engine respectively and said cavity is a cylinder bore.

4. The multifunctional gasket as set forth in claim 3, wherein said conductive metal base plate layer is constructed such that electric information generated in said cylinder bore is derived therethrough.

5. The multifunctional gasket as set forth in claim 3, wherein said conductive metal base plate layer is constructed such that electric power is supplied to an electric equipment provided in said cylinder bore therethrough.

6. The multifunctional gasket as set forth in claim 1, wherein said first base plate comprises plural conductive metal members separately insulated each other, as a substitute for said conductive metal base plate layer and through which electrical information is derived from plural points of said cavity.

7. The multifunctional gasket as set forth in claim 1, wherein said first base plate further comprises plural conductive metal members separately insulated each other between said conductive metal base plate layer and said insulation layer and through which electrical information is derived from plural points of said cavity.

8. The multifunctional gasket as set forth in claim 1, wherein said insulation layer is made of polyimide resin.

9. The multifunctional gasket as set forth in claim 2, wherein said two objects are a cylinder block and a cylinder head of an engine respectively and said cavity is a cylinder bore.
